(19) United States
(12) Patent Application Publication
(10) Pub. No.: US 2009/0083483 A1
(43) Pub. Date: Mar. 26, 2009

(54) Power Conservation In A RAID Array

(75) Inventors: Ganesh Balakrishnan, Apex, NC (US); Dustin M. Fredrickson, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/859,829

(22) Filed: Sep. 24, 2007

(51) Int. Cl. G06F 12/02

(52) U.S. Cl. 711/114; 711/E12.002

(57) ABSTRACT

Power conservation in a redundant array of inexpensive drives (‘RAID array’) that preserve RAID functionality, the RAID array including RAID subarrays of a same RAID specification, including powering off a drive in at least one of the RAID subarrays; responsive to a write request directed to a particular subarray containing a powered off drive, writing data redundantly to a RAID cache that is independent from the subarray having a powered off drive; powering on the powered-off drive; and flushing the written data from the cache to the particular subarray to which it was originally directed.

### BACKGROUND OF THE INVENTION

1. Field of the Invention

The field of the invention is data processing, or, more specifically, methods, apparatus, and products for power conservation in a RAID array.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is power conservation. Computer systems today are designed for optimizing application performance and to conserve power when the application load is reduced. Disk drives form an integral portion of the modern computer systems and are a key element in driving the performance needs of an application. On the other hand, disk drives also consume a significant portion of power in a computer system. So, there is a need to conserve disk power without compromising the performance of the storage subsystem.

### SUMMARY OF THE INVENTION

Methods, apparatus, and computer program products are disclosed for power conservation in a redundant array of inexpensive drives (‘RAID array’) that preserve RAID functionality, the RAID array including RAID subarrays of a same RAID specification, including powering off a drive in at least one of the RAID subarrays; responsive to a write request directed to a particular subarray containing a powered off drive, writing data redundantly to a RAID cache that is independent from the subarray having a powered off drive; powering on the powered-off drive; and flushing the written data from the cache to the particular subarray to which it was originally directed.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in power conservation in a RAID array according to embodiments of the present invention.

FIG. 2 sets forth a flow chart illustrating an exemplary method for power conservation in a RAID array according to embodiments of the present invention.

### DETAILED DESCRIPTION OF EXEMPLARY EMBODIMENTS

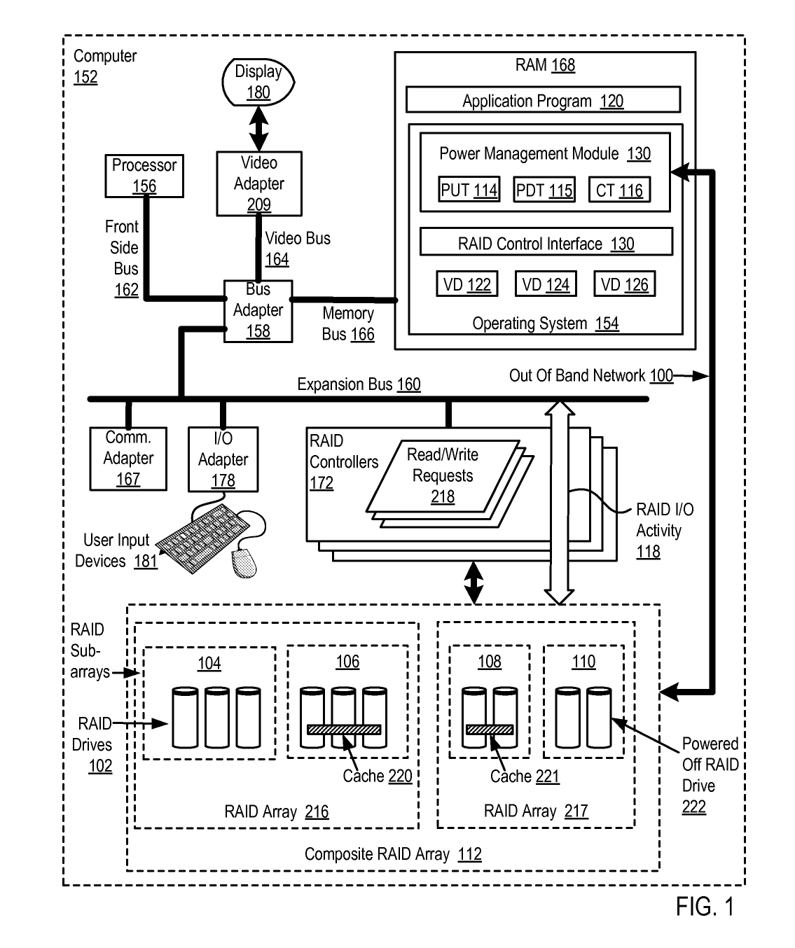

Exemplary methods, apparatus, and products for power conservation in a RAID array in accordance with the present invention are described with reference to the accompanying drawings, beginning with FIG. 1. FIG. 1 sets forth a block diagram of automated computing machinery comprising an exemplary computer (152) useful in power conservation in a RAID array according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an application program (120), a module of user-level computer program instructions for carrying out particular data processing tasks on the computer (152). Examples of such application programs include spreadsheets, word processing programs, email clients, web browsers, database management programs, and so on.

Also stored in RAM is a power management module (130), a module of computer program instructions that senses power-related characteristics of the computer (152) and turns on and off power to components of the computer in accordance with predefined protocols. An example of such protocol is the Advanced Configuration and Power Interface (‘ACPI’) specification, an open industry standard by HP, Intel, Microsoft, Phoenix, and Toshiba that defines common interfaces for hardware recognition, motherboard and device configuration and power management. A power management module that manages computer power according to ACPI, for example, may be improved to carry out power conservation in a RAID array according to embodiments of the present invention.

Also stored in RAM is a RAID control interface (130), a module of computer program instructions that provides a application programming interface or ‘API’ through which the power management module (130) can communicate with RAID controllers (172) to receive from the RAID controllers information regarding RAID input/output activity (118) and through which the power management module (130) can advise RAID controllers that a RAID drive (102, 222) is to be powered off. Also stored in RAM are several virtual drives (122, 124, 126), modules of computer program instructions that provide APIs for use by the operating system and the application program in writing and reading data to and from RAID drives (102).

Also stored in RAM (168) is an operating system (154). Operating systems useful power conservation in a RAID array according to embodiments of the present invention include UNIX™, Linux™, Microsoft XP™, AIX™, IBM's i5/OS™, and others as will occur to those of skill in the art. The operating system (154), the application program (120), the power management module (130), the RAID control interface (130), and the virtual drives (122, 124, 126) in the example of FIG. 1 are shown in RAM (168), but many components of such software typically are stored in non-volatile memory also, such as, for example, on RAID drives (102).

The computer (152) of FIG. 1 includes several RAID controllers (172) coupled through expansion bus (160) and bus adapter (158) to processor (156) and other components of the computer (152). RAID controllers (172) are computer input/output adapters that connect non-volatile data storage to the computer (152) in the form of RAID drives (102). The RAID controllers (172) organize the RAID drives (102) into RAID arrays (216, 217, 112) and expose storage capacity on the RAID drives to the operating system (154) and to application programs (120) in the form of virtual drives (122, 124, 126). The RAID controllers (172) administer read and write requests (218) directed to the virtual drives (122, 124, 126) as RAID I/O activity (118) to and from the RAID drives (102).

The RAID drives (102) are organized into two RAID arrays (216, 217), each of which operates two RAID subarrays (104, 106 and 108, 110) respectively. Each RAID subarray (104, 106) of RAID array (216) operates according to one RAID specification or ‘RAID level,’ and each RAID subarray (108, 110) of RAID array (217) operates according to one RAID specification. When the RAID specification of RAID array (216) is not the same as the RAID specification according to which RAID array (217) operates, the two RAID arrays (216, 217) operating according to different RAID levels form a ‘composite RAID array’ (112).

RAID levels include, for example:
RAID 0: A striped set of at least two RAID drives without parity. RAID 0 provides improved performance and additional storage but no fault tolerance from disk errors or disk failure. The striping allows smaller sections of an entire chunk of data to be read off the array in parallel, giving RAID 0 arrays large bandwidth. Hence RAID 0 arrays are fast, but they typically require additional backup to guard against disk failure.
RAID 1: A mirrored set of at least two RAID drives without parity. RAID 1 provides fault tolerance from disk errors and single disk failure. Increased read performance occurs when using a multi-threaded operating system that supports split seeks. Each array or subarray continues to operate so long as at least one drive is functioning.
RAID 3 and RAID 4: A striped set of at least three RAID drives with dedicated parity, where each parity bit represents a memory location, and each parity bit advises whether the represented memory location is empty or full, thus enhancing read and write speed. This mechanism provides an improved performance and fault tolerance similar to RAID 5, but with a dedicated parity disk rather than rotated parity stripes. The dedicated parity disk allows the parity drive to fail and operation will continue without parity or performance penalty.
RAID 5: A striped set of at least three RAID drives with distributed parity. Distributed parity requires all but one drive to be present to operate, although RAID functionality is not destroyed by a single drive failure. Upon drive failure, any subsequent reads can be calculated from the distributed parity so that the drive failure is masked from the end user.
RAID 6: A striped set of at least four RAID drives with dual distributed parity. RAID 6 provides fault tolerance from two drive failures; each array continues to operate with up to two failed drives. This makes larger RAID groups more practical, especially for high availability systems.

Composite RAID levels include, for example:
RAID 0+1: A striped set of RAID drives and a mirrored set of RAID drives comprising an even number of at least four disks—provides fault tolerance and improved performance but increases complexity. The key difference from RAID 1+0 is that RAID 0+1 creates a second striped set to mirror a primary striped set.
RAID 1+0: A mirrored set of RAID drives plus a striped set of RAID drives comprising at least four drives—provides fault tolerance and improved performance but increases complexity. The key difference from RAID 0+1 is that RAID 1+0 creates a striped set from a series of mirrored drives.
RAID 5+0: A stripe across distributed parity RAID systems.
RAID 5+1: A mirror striped set with distributed parity, sometimes characterized as RAID 5+3.

The computer of FIG. 1 operates generally to conserve power in a RAID array in a way that preserves RAID functionality by first powering off a drive (222) in at least one of the RAID subarrays (110). The example of FIG. 1 shows one drive powered off in one RAID subarray, but there is nothing in the scope of the present invention that limits the number of drives powered off to one or the number of affected subarrays to one. Any number of drives can be powered down in any number of subarrays as will occur to those of skill in the art, so long as the number of drives powered down and the number of subarrays affected preserves RAID functionality according to embodiments of the present invention.

The RAID drive powered down in this example is powered down by the power management module (130), which controls power to the powered down drive through out of band network (100), which may be, for example, an Inter-Integrated Circuit (‘I²C’) network, a System Management Bus (‘SMBus’), or other out of band network as may occur to those of skill in the art. The power management module (130) may use the RAID control interface (130) to communicate with RAID controllers and track the amount of RAID input/output activity (118), powering off a drive when RAID input/output activity drops below a predetermined power-down threshold (115), where the predetermined power-down threshold (115) is provided to the power management module as a system configuration parameter.

Responsive to a write request (218) directed to a particular subarray (110) containing a powered off drive (222), the computer (152) writes data redundantly to a RAID cache (221) that is independent from the subarray having a powered off drive. Data mirrored or striped according to a RAID specification generally cannot be written to a RAID subarray having a powered-off drive while preserving full RAID functionality—because the powered-off drive would typically be a destination for at least some of the written data. In the case of mirroring, the powered-off drive may be the target for a mirror of all the data written to the subarray. In the case of striping, the powered-off drive will typically be the target for storage of a least some of the data written to the subarray. This limitation is not so general for read data, which can typically be read back directly from mirroring subarrays and read back by inference with parity from striping subarrays—even when one or more drives in the subarray are powered down.

The RAID cache (221) is established by reserving a portion of the storage on RAID drives of another subarray (108), that is, a RAID subarray (108) other than the RAID subarray (110) having a powered-off drive, a RAID subarray (108) having no powered-off drive. The RAID cache (221) is striped or mirrored across the drives of its subarray (108) according to the same RAID specification or RAID level that is in use on the RAID subarray (110) containing the powered-off drive (222). Writing data redundantly to a RAID cache (221) therefore is carried out by writing data redundantly in accordance with a RAID specification. In this example, the data written to the cache (221) is written to the cache (221) in a subarray (108) having no powered-off drive according to the same RAID specification that is in use on the subarray (110) with the powered-off drive (222).

Also in this example, a RAID array is implemented as a composite RAID array (112) that includes two or more RAID arrays (216, 217) of two or more RAID specifications. That is, each of at least two RAID arrays (216, 217) that make up a composite RAID array (112) in this example implements a different RAID level. The configuration of the composite RAID array (112) gives the computer (152) the alternative of writing data redundantly to a RAID cache by writing data redundantly in accordance with a RAID specification to a cache (220) on a RAID array (216) separate from the RAID array (217) containing the powered off drive (222). That is, the computer in this example has the capability of writing data redundantly according to a RAID specification not only to a RAID cache (221) on a RAID subarray (108) of the same RAID level as the subarray (110) having a powered down drive (222), but also to a RAID cache (220) on an entirely different RAID array (216) implementing an entirely different RAID level.

Having powered off a drive and written data to a cache, the computer (152) in the example of FIG. 1 can also power on the powered off drive (222). The power management module (130) may receive from a RAID controller (172) through the RAID control interface (130) information indicating that a RAID cache is full, for example, or that the amount of written data in a RAID cache exceeds a predetermined cache threshold (116), where the predetermined cache threshold (116) is provided to the power management system (130) as a system configuration parameter. Alternatively, the power management module (130) may use the RAID control interface (130) to communicate with RAID controllers and track the amount of RAID input/output activity (118), powering on a drive when RAID input/output activity exceeds a predetermined power-up threshold (114), where the predetermined power-up threshold (114) is provided to the power management module as a system configuration parameter.

Powering on a drive previously powered off (222) returns its RAID subarray (110) to full read/write capability, subject to return to the subarray the data, originally intended for the subarray that was instead written to cache while the subarray had a drive powered down. The computer (152) therefore also has the capability of flushing written data from a RAID cache (220, 221) to the particular subarray (110) to which it was originally directed. The power management module effects the flushing written data from a RAID cache (220, 221) to the particular subarray (110) to which it was originally directed by advising a RAID controller (172) through the RAID control interface (130) of the fact that a drive previously powered off is currently again powered on.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers, including data communications through one or more data communications networks. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for power conservation in a RAID array according to embodiments of the present invention include modems for wired dial-up communications, Ethernet (IEEE 802.3) adapters for wired data communications network communications, and 802.11 adapters for wireless data communications network communications.

The arrangement of devices making up the exemplary computer illustrated in FIG. 1 are for explanation, not for limitation. Computers useful for power conservation in a RAID array according to various embodiments of the present invention may include additional processors, memory, I/O functionality, and other architectures, not shown in FIG. 1, as will occur to those of skill in the art. Various embodiments of the present invention may be implemented on a variety of hardware platforms in addition to those illustrated in FIG. 1.

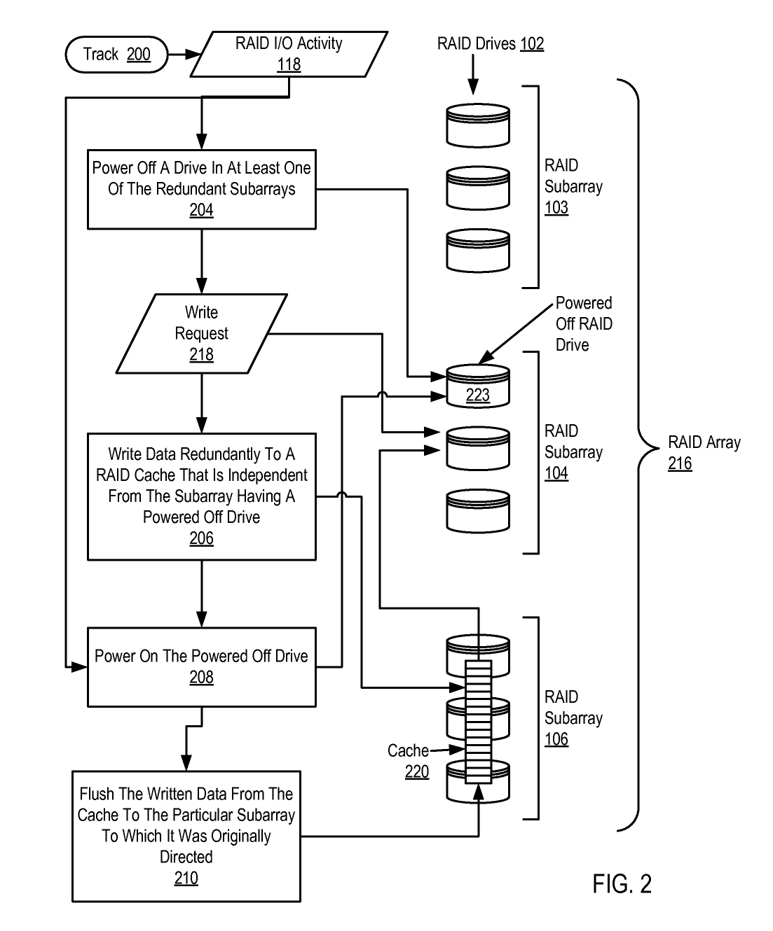

For further explanation, FIG. 2 sets forth a flow chart illustrating an exemplary method for power conservation in a RAID array according to embodiments of the present invention. The method of FIG. 2 is a computer-implemented method of power conservation that preserves RAID functionality. The method of FIG. 2 is implemented on a computer similar to the computer (152) of FIG. 1, a computer having at least one RAID array (216) that includes RAID subarrays (103, 104, 106) of a same RAID specification. For ease of explanation, therefore, the method of FIG. 2 is explained with reference to FIG. 1 as well as FIG. 2.

The method of FIG. 2 includes powering off (204) a drive (223) in at least one of the RAID subarrays (104). To illustrate the fact that RAID arrays according to embodiments of the present invention are not limited to two subarrays, the RAID array (216 on FIG. 2) is implemented with three subarrays (103, 104, 106) rather than the two subarrays of it counterpart (216) in the computer of FIG. 1. Similarly, the powered-down drive (223) in the example of FIG. 2 is chosen from a different subarray (104) than the powered down drive (222, 110) in the example of FIG. 1. The method of FIG. 1 can also include tracking (200), by a power management module (130), RAID input/output activity (118), so that powering off (204) a drive (223) in a RAID subarray (104) can be carried out by powering off a drive when RAID input/output activity drops below a predetermined power-down threshold (115).

Responsive to a write request (218) directed to a particular subarray (104) containing a powered off drive (223), the method of FIG. 2 includes writing (206) data redundantly to a RAID cache (220) that is independent from the subarray (104) having a powered off drive (223). The RAID cache (220) to which the data is written is independent from the subarray (104) having a powered off drive (223) in that the cache (220) is established, by striping or mirroring data according to a RAID level, on a completely separate subarray (106) from the subarray having the powered-down drive. Writing (206) data redundantly to the RAID cache (220) means writing data redundantly in accordance with a RAID specification, including writing data redundantly in accordance with a RAID specification to a cache (220) on a RAID subarray (106) having no powered-off drive. In computer systems having a composite RAID array that includes two or more RAID arrays of two or more RAID specifications, like the computer system of FIG. 1, writing (206) data redundantly to a RAID cache can be carried out by writing data redundantly in accordance with a RAID specification to a cache (221) on a RAID array (217) separate from the RAID array (216) containing the powered-off drive (223).

The method of FIG. 2 includes powering on (208) the powered-off drive. Powering on (208) the powered-off drive (223) can be carried out by a power management module (130) by powering-on the powered off drive when RAID input/output activity (118) exceeds a predetermined power-up threshold (114). Alternatively, powering-on (208) the powered off drive can be carried out powering on the powered-off drive when the amount of written data in the RAID cache (220) exceeds a predetermined cache threshold (116).

The method of FIG. 2 also includes flushing (210) the written data from the cache (220) to the particular subarray (104) to which it was originally directed. The particular subarray to which the written data was originally directed is the subarray (104) having the previously powered-down drive (223). While the drive (223) was powered down, data intended to be written to its subarray (104) was instead written to the cache (220). Now that the previously-powered-down drive (223) is again powered up, the written data that was originally intended for the subarray (104) containing the powered-down drive can be flushed to the subarray (104) containing the previously-powered-down drive, thereby returning that subarray (104) to full read/write capability.

In view of the explanations set forth above, readers will recognize that the benefits of power conservation in a RAID array according to embodiments of the present invention include preserving, from the point of view of application programs and operating systems full RAID capability of a RAID array or subarray having one more more RAID drives powered down.

Exemplary embodiments of the present invention are described largely in the context of a fully functional computer system for power conservation in a RAID array. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of power conservation in a redundant array of inexpensive drives (‘RAID array’) that preserves RAID functionality, the RAID array comprising RAID subarrays of a same RAID specification, the method comprising:
powering off a drive in at least one of the RAID subarrays;
responsive to a write request directed to a particular subarray containing a powered off drive, writing data redundantly to a RAID cache that is independent from the subarray having a powered off drive;
powering on the powered-off drive; and
flushing the written data from the cache to the particular subarray to which it was originally directed.

2. The method of claim 1 wherein writing data redundantly to a RAID cache further comprises writing data redundantly in accordance with a RAID specification.

3. The method of claim 1 wherein writing data redundantly to a RAID cache further comprises writing data redundantly in accordance with a RAID specification to a cache on a RAID subarray having no powered-off drive.

4. The method of claim 1 wherein:
the RAID array is a composite RAID array comprising two or more RAID arrays of two or more RAID specifications; and
writing data redundantly to a RAID cache further comprises writing data redundantly in accordance with a RAID specification to a cache on a RAID array separate from the RAID array containing the powered-off drive.

5. The method of claim 1 further comprising tracking RAID input/output activity, wherein:
powering off a drive in at least one of the RAID subarrays further comprises powering off a drive when RAID input/output activity drops below a predetermined power-down threshold, and
powering on the powered-off drive further comprises powering on the powered-off drive when RAID input/output activity exceeds a predetermined power-up threshold.

6. The method of claim 1 wherein powering on the powered-off drive further comprises powering on the powered-off drive when the amount of written data in the RAID cache exceeds a predetermined cache threshold.

7. Apparatus for power conservation in a redundant array of inexpensive drives (‘RAID array’) that preserves RAID functionality during power conservation operations, the RAID array comprising RAID subarrays of a same RAID specification, the apparatus comprising a computer processor, a computer memory operatively coupled to the computer processor, the computer memory having disposed within it computer program instructions capable of:
powering off a drive in at least one of the RAID subarrays;
responsive to a write request directed to a particular subarray containing a powered off drive, writing data redundantly to a RAID cache that is independent from the subarray having a powered off drive;
powering on the powered-off drive; and
flushing the written data from the cache to the particular subarray to which it was originally directed.

8. The apparatus of claim 7 wherein writing data redundantly to a RAID cache further comprises writing data redundantly in accordance with a RAID specification.

9. The apparatus of claim 7 wherein writing data redundantly to a RAID cache further comprises writing data redundantly in accordance with a RAID specification to a cache on a RAID subarray having no powered-off drive.

10. The apparatus of claim 7 wherein:
the RAID array is a composite RAID array comprising two or more RAID arrays of two or more RAID specifications; and
writing data redundantly to a RAID cache further comprises writing data redundantly in accordance with a RAID specification to a cache on a RAID array separate from the RAID array containing the powered-off drive.

11. The apparatus of claim 7 further comprising computer program instructions capable of tracking RAID input/output activity, wherein:
powering off a drive in at least one of the RAID subarrays further comprises powering off a drive when RAID input/output activity drops below a predetermined power-down threshold, and
powering on the powered-off drive further comprises powering on the powered-off drive when RAID input/output activity exceeds a predetermined power-up threshold.

12. The apparatus of claim 7 wherein powering on the powered-off drive further comprises powering on the powered-off drive when the amount of written data in the RAID cache exceeds a predetermined cache threshold.

13. A computer program product for power conservation in a redundant array of inexpensive drives (‘RAID array’) that preserves RAID functionality during power conservation operations, the RAID array comprising RAID subarrays of a same RAID specification, the computer program product disposed in a signal bearing medium, the computer program product comprising computer program instructions capable of:
powering off a drive in at least one of the RAID subarrays;
responsive to a write request directed to a particular subarray containing a powered off drive, writing data redundantly to a RAID cache that is independent from the subarray having a powered off drive;
powering on the powered-off drive; and
flushing the written data from the cache to the particular subarray to which it was originally directed.

14. The computer program product of claim 13 wherein the signal bearing medium comprises a recordable medium.

15. The computer program product of claim 13 wherein the signal bearing medium comprises a transmission medium.

16. The computer program product of claim 13 wherein writing data redundantly to a RAID cache further comprises writing data redundantly in accordance with a RAID specification.

17. The computer program product of claim 13 wherein writing data redundantly to a RAID cache further comprises writing data redundantly in accordance with a RAID specification to a cache on a RAID subarray having no powered-off drive.

18. The computer program product of claim 13 wherein:
the RAID array is a composite RAID array comprising two or more RAID arrays of two or more RAID specifications; and
writing data redundantly to a RAID cache further comprises writing data redundantly in accordance with a RAID specification to a cache on a RAID array separate from the RAID array containing the powered-off drive.

19. The computer program product of claim 13 further computer program product comprising computer program instructions capable of comprising tracking RAID input/output activity, wherein:
powering off a drive in at least one of the RAID subarrays further comprises powering off a drive when RAID input/output activity drops below a predetermined power-down threshold, and
powering on the powered-off drive further comprises powering on the powered-off drive when RAID input/output activity exceeds a predetermined power-up threshold.

20. The computer program product of claim 13 wherein powering on the powered-off drive further comprises powering on the powered-off drive when the amount of written data in the RAID cache exceeds a predetermined cache threshold.
